(19) United States
(12) Patent Application Publication
(10) Pub. No.: US 2009/0049540 A1
(43) Pub. Date: Feb. 19, 2009

(54) METHOD AND SYSTEM FOR PROVIDING TARGETED WEB FEED SUBSCRIPTION RECOMENDATIONS CALCULATED THROUGH KNOWLEDGE OF IP ADDRESSES

(76) Inventors: Ayman S. Khalil, Boston, MA (US); Henry Y. Wong, Cambridge, MA (US); Michael W. Sorenson, Cambridge, MA (US)

Correspondence Address: LOTUS AND RATIONAL SOFTWARE;David A. Dagg, Esq., 44 Chapin Road, Newton, MA, 02459, US

(21) Appl. No.: 11/840,938

(22) Filed: Aug. 18, 2007

(51) Int. Cl. G06F 15/16

(52) U.S. Cl. 726/14

(57) ABSTRACT

A system for providing targeted Web feed subscription suggestions calculated based on IP (“Internet Protocol”) addresses. Web feeds are automatically suggested to users based on the IP (Internet Protocol) address of the user's computer system and previous feed subscriptions made from other computer systems having similar IP addresses. Feed suggestions may be weighted based on differing levels of IP address similarity, in order to reflect differing levels of geographic proximity between users. Users may be permitted to expressly indicate which of their feed subscriptions are to be made public through the feed reader user interface when they make subscriptions. In response to such user indications, the disclosed system passes the IP address of the user's computer system to the centralized server system together with a name or other identifier of the feed that was subscribed to.

### FIELD OF THE INVENTION

The disclosed system relates generally to subscriptions to Web feeds, and more specifically to a method and system for providing targeted Web feed subscription suggestions calculated through knowledge of IP (“Internet Protocol”) addresses.

### BACKGROUND OF THE INVENTION

As it is generally known, Web feed technologies such as RSS (“Real Simple Syndication”) and Atom allow a user to quickly aggregate Web pages and other information. However, in many cases the user is required to manually discover and subscribe to each feed. In addition, users often have difficulty judging the usefulness of individual feeds before they subscribe to them. As a result, users may have to manually subscribe to a large number of feeds without knowing which ones will be helpful, and then later unsubscribe from the less useful ones. Such an approach is time consuming and inefficient.

One existing technique to make feed reader programs more “user-friendly” has been to apply a search engine to the problem of discovering interesting feeds that can be subscribed to (e.g. as provided by RSS Compendium at http://allrss.com/rsssearch.html). Existing feed readers using this approach typically include an interface to search an assortment of RSS feeds on the Web. Although searching in this way is useful for finding feeds about specific topics, it does not help the user find useful and/or interesting feeds that he or she does not actively search for, since the user must have a specific topic in mind and be actively searching for it in order to discover new feeds.

Other existing systems, such as Google's Feed Reader (https://www.google.com/reader/view/), come pre-loaded with a number of the most popular RSS news feeds on the Web. These systems help novice users get acquainted with RSS feed readers, but the value of the initial suggested feeds diminishes once the user gains some familiarity with the technology and seeks to better customize his or her reader configuration. In addition, pre-loading a feed reader with feeds does not provide a way for existing users to subsequently obtain relevant suggested feed subscriptions through their readers.

For the above reasons and others, it would be desirable to have a new system that provides users with suggested feeds that they are likely to find useful. The system should be able to automatically pre-populate a feed reader, and also be able to be invoked at any time to in order to obtain an current, up to date list of feeds that a user is likely to find useful.

### SUMMARY OF THE INVENTION

To address the above described and other shortcomings of previous techniques, a method and system are disclosed for providing targeted Web feed subscription suggestions calculated through knowledge of IP (“Internet Protocol”) addresses. In the disclosed system, Web feeds are automatically suggested to users based the similarity of the IP (Internet Protocol) address of their computer system and IP addresses of other computer systems through which previous feed subscriptions were made.

Since IP addresses are typically distributed geographically, computer systems with similar IP numbers tend to be physically proximate. As a result, users of computer systems with similar IP addresses tend to have similar roles and requirements. For example, computer systems located within a software company are typically mostly used by software developers or the like. The disclosed system generates and maintains a centralized database and a user-transparent feed weighting mechanism from which can be obtained a set of recommended feeds for a user of a computer system with a given IP address.

The disclosed system allows users to receive accurately targeted feed recommendations, while also remaining current on what feeds are being widely viewed in all locations. For example, if a group of geographically proximate computer systems are subscribed to technology news feeds (e.g. Slashdot or Wired), then the disclosed system will suggest these feeds to a new user with an IP address that is similar to the IP addresses used by those computer systems, without manual intervention by a central administrator.

Feed suggestions provided by the disclosed system to a requesting user may be weighted (i.e. prioritized) based on differing levels of IP address similarity, in order to reflect differing levels of geographic proximity between users. For example, feed subscriptions associated with IP addresses having a relatively higher level of similarity to the IP address of a user's computer system may be weighted relatively highly, since such subscriptions are generally from a relatively smaller geographic area including the user's computer system, and other users most closely located to the user are likely to be most similar to the user in terms of feed interests. Similarly, feed subscriptions associated with IP addresses having a relatively lower level of similarity to the IP address of a user's computer system may be weighted relatively lower, since such subscriptions are from within a relatively larger geographic area including the user's computer system, and accordingly reflect the interests of other users that are less physically proximate. Thus, for example, in one embodiment of the disclosed system, a feed subscription from a computer system with an IP address with N most significant bytes matching the IP address of a user's computer system would be weighted more heavily for purposes of generating suggested feeds for that user than a feed subscription from a computer system with an IP address having less than N most significant bytes matching the IP address of that user's computer system.

The IP addresses and associated feed subscriptions in the disclosed system may be collected in any way appropriate for a given embodiment. For example, in one embodiment, users are permitted to expressly indicate which of their feed subscriptions are to be made public in the feed reader user interface when they make subscriptions. In response to such user indications, the disclosed system passes the IP address of the user's computer system to the centralized server system together with a name or other identifier of the feed that was subscribed to.

Thus there is disclosed a new method and system that provides users with suggested feeds that they might find useful. The disclosed system can automatically pre-populate a feed reader with suggested feeds targeted to a specific user, and can further be manually invoked at any time to get an up to date list of suggested feeds that the user might find useful.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram showing hardware and software components in an illustrative embodiment of the disclosed system;

FIG. 2 is a flow chart showing steps performed in an illustrative embodiment of the disclosed system;

FIG. 3 is a simplified screen shot showing an example of a feed reader user interface generated in an illustrative embodiment;

FIG. 4 is a simplified screen shot showing an example of an add feed user interface generated in an illustrative embodiment;

FIG. 5 is a simplified screen shot showing an example of a suggested feeds user interface generated in an illustrative embodiment; and

FIG. 6 is a simplified screen shot showing an example of a suggested feeds configuration user interface generated in an illustrative embodiment.

### DETAILED DESCRIPTION OF EXEMPLARY EMBODIMENTS

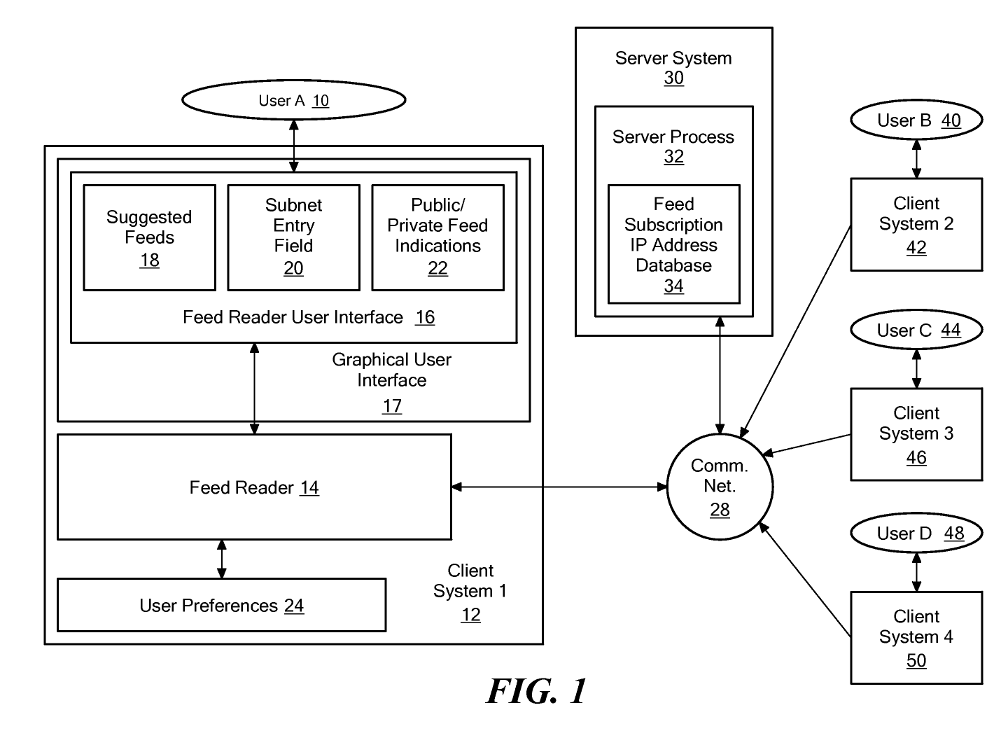

FIG. 1 is a block diagram showing hardware and software components in an illustrative embodiment of the disclosed system. As shown in FIG. 1, a User A 10 of a Client System 1 12 is provided with a Feed Reader User Interface 16 within a Graphical User Interface 17 by a Feed Reader 14. The Feed Reader User Interface 16 and operation of the Feed Reader 14 may be determined in part by the contents of User Preferences 24. The Feed Reader User Interface 16 is shown including Suggested Feeds 18, a Subnet Entry Field 20, and Public/Private Feed Indications 22 user interface display objects.

The Client System 1 12 is communicably coupled to a Communication Network 28, to which are also connected a Server System 30, Client System 2 42 of User B 40, Client System 3 46 of User C 44, and Client System 4 50 of User D 48. The Server System 30 includes a Server Process 32, which maintains and provides access to a Feed Subscription/IP Address Database 34. While not shown in FIG. 1 for purposes of concise illustration, each of the client systems 42, 46 and 50 further includes a feed reader, graphical user interface, feed reader user interface, and user preferences, as are shown in FIG. 1 for Client System 1 12.

During operation of the embodiment of FIG. 1, the Feed Reader 14 operates as a feed aggregator, and may be embodied as client software, firmware, and/or hardware, and/or as a Web application. The Feed Reader 14 aggregates syndicated Web content such as news headlines, blogs, podcasts, and vlogs for viewing by User A 10. Once User A 10 has subscribed to a given feed, Feed Reader 14 checks for and retrieves new content in that feed, e.g. periodically at user-determined time intervals. For example, the syndicated content retrieved from feeds by Feed Reader 14 may be supplied in the form of RSS or other XML-formatted data, such as RDF/XML and/or Atom.

Further during operation of the embodiment shown in FIG. 1, the Server Process 32 maintains the Feed Subscription/IP Address Database 34 based on collected information indicating the IP addresses of the system from which each feed subscription is made. For example, in one embodiment, each time one of user's A 10, B 40, C 44 or D 48 subscribes to a feed, they may indicate that the subscription is or is not to be made public. When a feed subscription is indicated by the subscribing user as public, the IP address of the machine used to make that subscription is sent with a name or other identifier of the feed to the server process 32. Accordingly, when User B subscribes to a feed, the name of that feed, and the IP address of Client System 2 42, are sent to Server Process 32. The Server Process 32 then forms an association between the IP address of Client System 42 and the feed identifier in the Feed Subscription/IP Address Database 34. Based on such associations, the Feed Subscription/IP Address Database 34 can be used to retrieve information describing the IP addresses of systems that have been used to subscribe to a specific feeds. For example, the Feed Subscription/IP Address Database 34 may be embodied to store each IP address of each system used to subscribe to each individual feed. Alternatively, the Feed Subscription/IP Address Database 34 may be designed to represent the relationship between feeds and subscribing system IP addresses in other ways, e.g. by maintaining per-feed counts of subscribing system IP addresses within each of a number of pre-determined IP subnets, etc.

In one embodiment of the disclosed system, users are allowed to indicate whether their feed subscriptions are public or not at the time they subscribe to the feeds through Public/Private Feed Indications 22. This feature enables the user to have control over whether the IP address of their system is associated with a given feed in the Feed Subscription/IP Address Database 34. If a feed subscription is not made public, the IP address of the system through which the subscription was made is not sent to the Feed Subscription/IP Address Database 34.

The disclosed system may be embodied to determine feed suggestions based on the similarity of IP addresses associated with feeds in the Feed Subscription/IP Address Database 34 to the IP address of a user's system. In such an embodiment, subscriptions through machines having IP addresses more similar to the IP address of a given user's system are weighted relatively heavily, so that such subscriptions are more likely to result in a feed being recommended to that user than subscriptions through machines having IP addresses relatively less similar to the IP address of the user's system.

For example, the disclosed system may be embodied and/or configured to operate such that every time a user subscribes to or unsubscribes from a feed a message is sent from that user's client system (e.g. Client System 1 12, Client System 2 42, Client System 3 46, or Client System 4 50) to a central server (e.g. Server System 30), in order to maintain records of the number of current subscriptions for each feed, together with the IP addresses associated with each feed subscription. Thus, each current feed subscription and associated IP address is a “vote” for the corresponding feed to be included as a suggested feed. When suggested feeds are generated for a specific given user, e.g. in response to the user's request for suggested feeds, the disclosed system assigns a weight to each stored vote, depending on similarity of the vote's associated IP address to the IP address of the system of the user for whom suggestions are being generated. If a sum of weighted votes for a given feed is then determined to be above a certain threshold, then the feed is included within the suggested feeds for that user.

For example, in one embodiment of the disclosed system, a weighting mechanism is used in which every vote (i.e. subscription) cast from within the same class B subnet (ex: 9.33.x.x) as the requesting user is assigned a weight of 1, while all other votes (i.e. subscriptions) receive a weight of 0. This type of embodiment of the disclosed system shows how the disclosed system can operate using IP address similarity tests such that subscriptions/votes made through nearby machines will typically count more heavily (i.e. be considered more significant) than those made through machines that are less proximate to the system of the user for whom feed suggestions are being generated.

Now again with reference to FIG. 1, a use case of an embodiment of the above described embodiment of the disclosed system is described, in which User A 10 has requested feed suggestions. In the use case example, previous feed subscriptions were as follows: User B 40 has subscribed to Feed 1, Feed 2 and Feed 4, User C 44 has subscribed to Feed 1, Feed 2 and Feed 3, and User D has subscribed to Feed 1, Feed 2 and Feed 4. Further in the use case example, the IP address of Client System 1 12 is 9.33.10.233, the IP address of Client System 2 42 is 9.45.0.1, the IP address of Client System 3 46 is 9.33.10.231, and the IP address of Client System 4 50 is 9.33.10.232. Based on this set of previous subscriptions and IP address information, the subscriptions of User B 40 are not counted towards the recommendations for User A 10, because the IP address of Client System 2 42 is not in the same class B subnet as Client System 1 12 (9.45.x.x vs. 9.33.10.233). Of the remaining subscriptions, assuming a minimum required subscription threshold of 2 (e.g. equal to a majority of the client systems for which at least one subscription has been received), there are not enough subscriptions to suggest Feed 3 or Feed 4, so only Feed 1 and Feed 2 are suggested to User A 10 (e.g. through the Suggested Feeds 18).

Alternatively, or in addition, the disclosed system may be embodied such that a user can indicate an IP subnetwork of interest from which the Suggested Feeds 18 are to be generated, e.g. through the Subnet Entry Field 20. For example, if User A 10 were to indicate an interest in IP Subnet X through the Subnet Entry Field 20 (e.g. by entering a subnet mask or the like into Subnet Entry Field 20), then Subnet X would be stored in the User Preferences 24, and an embodiment of the disclosed system would operate to generate Suggested Feeds 18 based on subscription activity within Subnet X. For example, the Suggested Feeds 18 could include the N most subscribed to feeds within Subnet X, e.g. based on comparison of subscribing system IP addresses and the subnet mask for Subnet X.

Those skilled in the art will recognize that the disclosed system is not limited to the specific subscription weighing mechanism and/or required subscription threshold for suggesting a feed described above, and accordingly that alternative embodiments and/or configurations may use different weighing mechanisms and/or required subscription thresholds as may be appropriate.

While for purposes of concise illustration only four users (User A 10, User B 40, User C 44 and User D 48)) are shown in FIG. 1, those skilled in the art will recognize that the disclosed system may be embodied such that any specific number of users may be supported. Similarly, while only four client systems (Client System 1 12, Client System 2 42, Client System 3 46 and Client System 4 50)) and one server system (Server System 30) are shown in FIG. 1, the disclosed system may be embodied to operate on any specific number of client and/or server systems.

The client systems of FIG. 1 may be any specific type of a computer system or intelligent electronic device, such as a desktop, laptop, or palmtop computer system, or a personal digital assistant, cell phone, or other electronic device. The client systems of FIG. 1 each include or control a display device capable of displaying a graphical user interface (e.g. the Graphical User Interface 17) to a local user (e.g. User A 10), such as a liquid crystal display (LCD), cathode ray tube (CRT), interferometric modulator display (IMOD), light emitting diode (LED), or the like.

Those skilled in the art will recognize that the Feed Reader 14 and/or Server Process 32 may be embodied using software or firmware, such as computer application program code, operating system program code, middleware, and/or wholly or partly using digital hardware components, such as application specific integrated circuits (ASICs), field-programmable gate arrays (FPGAs), and the like, and/or combinations of hardware and/or software or firmware. Those skilled in the art will further recognize that the client systems and/or server system, and/or any other client systems or server systems within the Communication Network 28, may include one or more processors, and program storage, such as memory, for storing program code executable on such processors, as well as input/output devices and/or interfaces. In the example of FIG. 1, the client systems 12, 42, 46 and 50, and Server System 30, are interconnected through a computer or data Communication Network 28 (e.g. the Internet, a Local Area Network, etc.) through one or more of such input/output devices or interfaces, and through which may further be provided communication to a number of other client systems and/or other server systems.

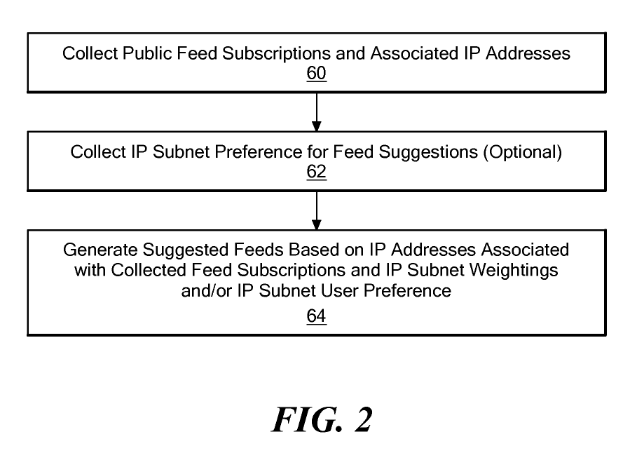

FIG. 2 is a flow chart showing steps performed in an illustrative embodiment of the disclosed system. At step 60, the disclosed system collects information regarding current feed subscriptions, such as feed identifiers and the IP addresses of the system through which the feed subscriptions are made. At the optional step 62, the disclosed system operates to obtain a subnet preference for a local user, such that feed suggestions are generated based on the most frequently subscribed to feeds within an IP subnet specified by the local user. The disclosed system may or may not be embodied to include step 62.

At step 64, the disclosed system generates suggested feeds for a user based on the IP addresses associated with feed subscriptions, and potentially also such that subscriptions are more heavily weighted when their associated IP address is more similar to the IP address of the requesting user's system, and/or such that only subscriptions within the subnet indicated by the requesting user are counted to determine the suggested feeds for that user.

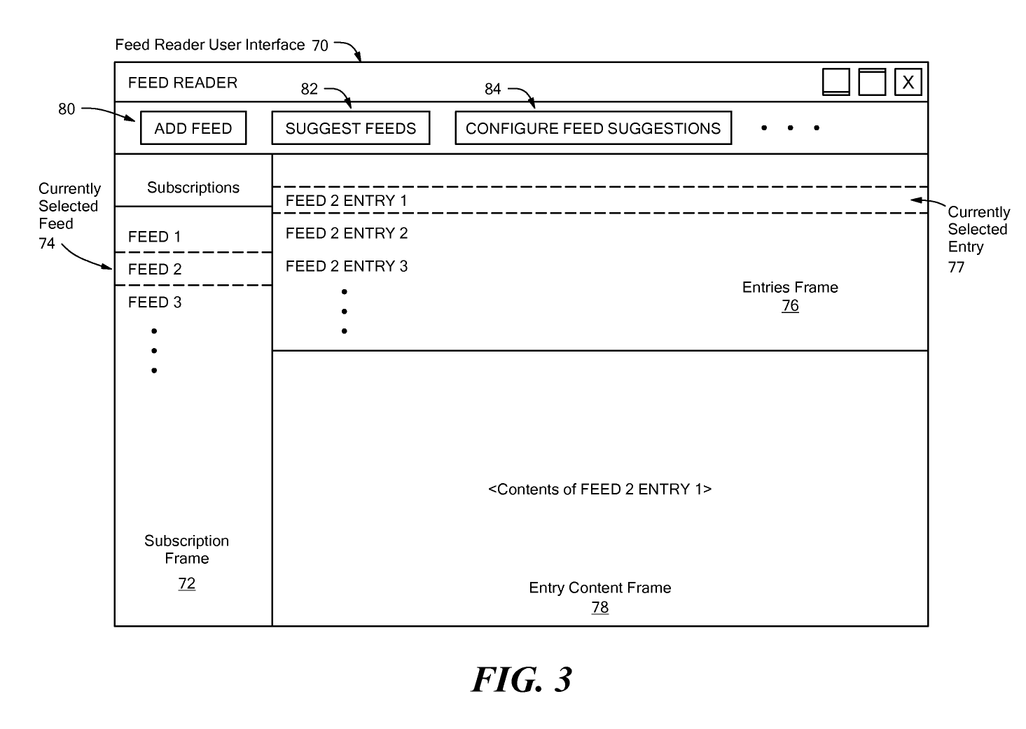

FIG. 3 is a simplified screen shot showing an example of a Feed Reader User Interface 70 generated in an illustrative embodiment of the disclosed system. The Feed Reader User Interface 70 of FIG. 3 includes a Subscription Frame 72 containing a list of feeds to which the local user has subscribed, including a Currently Selected Feed 74. An Entries Frame 76 displays feed entries of the Currently Selected Feed 74, including a Currently Selected Entry 77, and an Entry Content Frame 78 contains the contents of the Currently Selected Entry 77. Features of the disclosed system may be accessed through user interface display objects such as the Add Feed button 80, Suggest Feeds button 82, and/or Configure Feed Suggestions button 84.

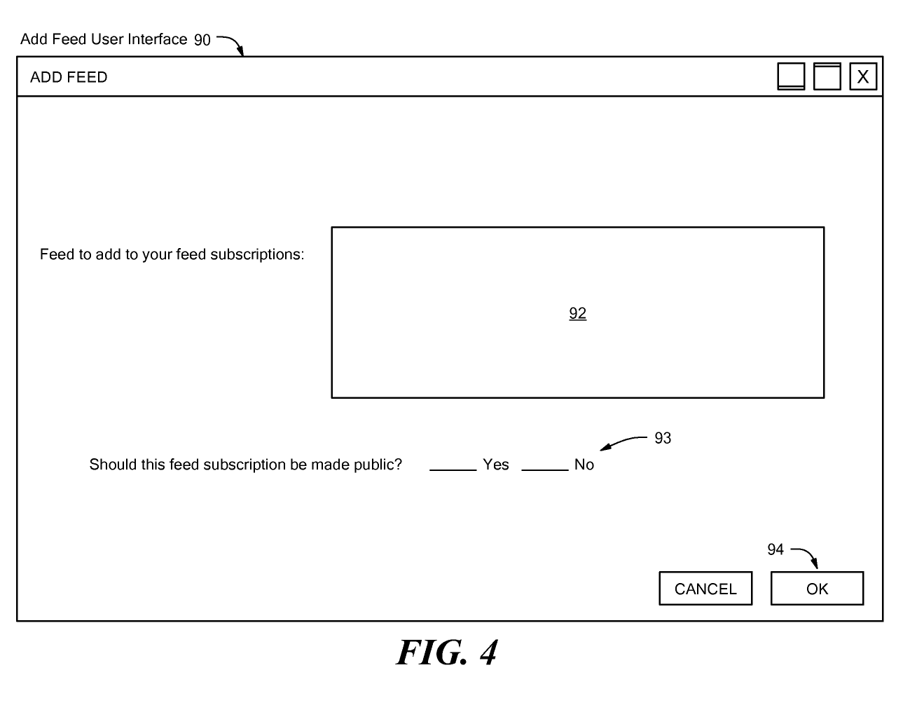

FIG. 4 is a simplified screen shot showing an example of an Add Feed User Interface 90 generated in an illustrative embodiment in response to the user clicking on the Add Feed button 80 shown in FIG. 3. As shown in FIG. 4, a field 92 is provided for the user to enter a new feed to be added to the user's list of feed subscriptions. The user is further allowed to provide an indication through the prompt 93 as to whether the feed subscription is to be made public or not. If the user indicates that the feed subscription is to be made public, then a feed identifier and the IP address of the user's client system are sent to a central server to be added to and/or represented in a database (e.g. Feed Subscription/IP Address Database 34 of FIG. 1). For purposes of illustration, the feed indicated in field 92 is added to the user's feed subscriptions when the user clicks on the OK button 94.

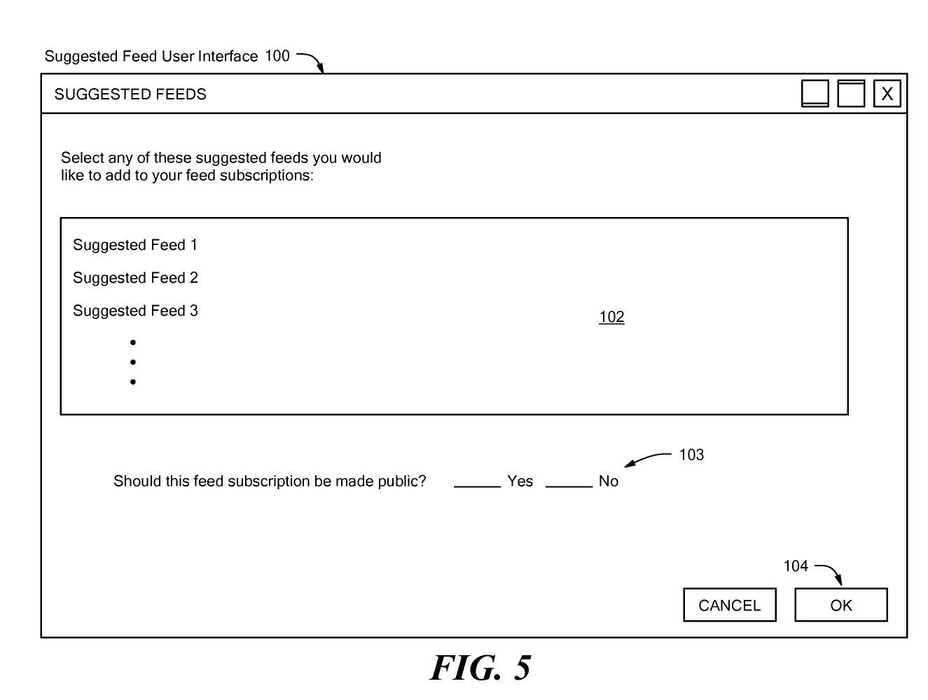

FIG. 5 is a simplified screen shot showing an example of a Suggested Feeds User Interface 100 generated in an illustrative embodiment of the disclosed system, for example in response to the user clicking on the Suggest Feeds button 82 shown in FIG. 3. As shown in FIG. 5, a list of suggested feeds 102 is displayed to the user, and the user is then allowed to select from those suggested feeds 102 specific feeds to which they wish to subscribe. The user is further enabled to indicate whether subscriptions to the feeds selected from the suggested feeds 102 are to be made public through the prompt 103. For purposes of illustration, when the user clicks on the OK button 104 the selected ones of the suggested feeds 102 are added to the user's feed subscriptions.

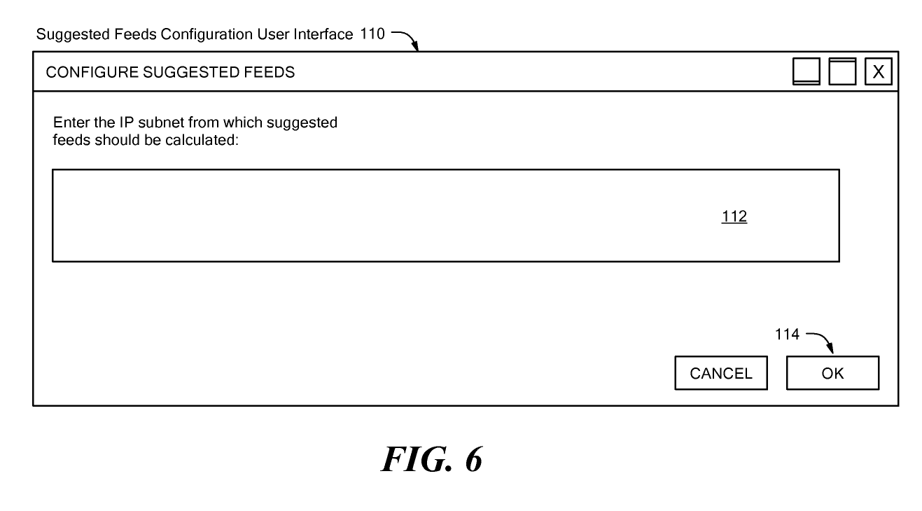

FIG. 6 is a simplified screen shot showing an example of a Suggested Feeds Configuration User Interface 110 generated in an illustrative embodiment, for example in response to a user clicking on the Configure Feed Suggestions button 84 shown in FIG. 3. The Suggested Feeds Configuration User Interface 110 includes a field 112 into which the user can enter an indication (e.g. Subnet Mask) of a subnetwork from within which feed subscriptions are to be considered when calculating suggested feeds for the user. For purposes of illustration, when the user clicks on the OK button 114, the subnet indication in the field 112 is stored into the user's configuration preferences (e.g. User Preferences 24 shown in FIG. 1).

While the above description regarding illustrative embodiments of the disclosed system includes examples of specific user interface display objects, such as graphical buttons, menus, dialog boxes, and the like, the present invention is not limited to those specific examples. Accordingly, those skilled in the art will recognize that alternative embodiments may use any specific type or kind of user interface display object that may be appropriate.

The disclosed system can take the form of an entirely software embodiment, an entirely hardware embodiment, or an embodiment containing both software and hardware elements. The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed.

We claim:

1. A method for providing targeted Web feed subscription suggestions, comprising:
collecting a plurality of Web feed subscriptions, wherein each one of said collected Web feed subscriptions is associated with an Internet Protocol (IP) address of a machine through which it was made;
generating at least one suggested Web feed for a user based on similarity of an IP address associated with a machine used by said user to IP addresses associated with said collected Web feed subscriptions; and
displaying said at least one suggested Web feed to said user in a graphical user interface of said machine used by said user.

2. The method of claim 1, wherein said generating said at least one suggested Web feed further comprises:
weighting each of said collected Web feed subscriptions based on how similar said IP address of said machine through which said subscription was made is to said IP address associated with said machine of said user, such that those of said collected Web feed subscriptions associated with IP addresses that are more similar to said IP address associated with said machine of said user are prioritized over those of said collected Web feed subscriptions associated with IP addresses that are less similar to said IP address associated with said machine of said user.

3. The method of claim 2, wherein a first IP address is determined to be more similar to a second IP address than a third IP address is to said second IP address when said first IP address includes more most significant bytes in common with said second IP address than said third IP address has in common with said second IP address.

4. The method of claim 3, wherein said collecting said plurality of Web feed subscriptions further comprises:
generating a user interface option allowing indication of whether a Web feed subscription is to be made public;
responsive to said indication that said Web feed subscription is to be made public, sending an IP address of a machine through which said subscription was made to a central server system together with an identifier of said Web feed subscription; and
associating said IP address of said machine through which said subscription was made with said identifier of said Web feed subscription in said central server system.

5. The method of claim 1, further comprising:
generating a user interface option allowing indication of a subnet from which said at least one suggested Web feed subscription is to be generated; and
wherein said generating said at least one suggested Web feed subscription is responsive only to those of said collected Web feed subscriptions that are associated with IP addresses matching said indicated subnet.

6. A computer system including a computer readable memory, said computer system including at least one processor, said computer readable memory having program code stored thereon, wherein said program code, when executed, causes said computer system to provide targeted Web feed subscription suggestions by performing steps comprising:
collecting a plurality of Web feed subscriptions, wherein each one of said collected Web feed subscriptions is associated with an Internet Protocol (IP) address of a machine through which it was made;
generating at least one suggested Web feed for a user based on similarity of an IP address associated with a machine used by said user to IP addresses associated with said collected Web feed subscriptions; and
displaying said at least one suggested Web feed to said user in a graphical user interface of said machine used by said user.

7. The computer system of claim 6, further comprising:
wherein said generating said at least one suggested Web feed further includes weighting each of said collected Web feed subscriptions based on how similar said IP address of said machine through which said subscription was made is to said IP address associated with said machine of said user, such that those of said collected Web feed subscriptions associated with IP addresses that are more similar to said IP address associated with said machine of said user are prioritized over those of said collected Web feed subscriptions associated with IP addresses that are less similar to said IP address associated with said machine of said user.

8. The system of claim 7, further comprising:
wherein a first IP address is determined to be more similar to a second IP address than a third IP address is to said second IP address responsive to a calculation indicating that said first IP address includes more most significant bytes in common with said second IP address than said third IP address has in common with said second IP address.

9. The system of claim 8, further comprising:
wherein said collecting said plurality of Web feed subscriptions further includes
generating a user interface option allowing indication of whether a Web feed subscription is to be made public,
responsive to said indication that said Web feed subscription is to be made public, sending an IP address of a machine through which said subscription was made to a central server system together with an identifier of said Web feed subscription, and
associating said IP address of said machine through which said subscription was made with said identifier of said Web feed subscription in said central server system.

10. The system of claim 6, wherein said steps performed by said computer system in response to execution of said program code stored in said computer readable memory further comprise:
generating a user interface option allowing indication of a subnet from which said at least one suggested Web feed subscription is to be generated; and
wherein said generating said at least one suggested Web feed subscription is responsive only to those of said collected Web feed subscriptions that are associated with IP addresses matching said indicated subnet.

11. A computer program product including a computer readable medium, said computer readable medium having stored thereon program code for providing targeted Web feed subscription suggestions, said program code comprising:
program code for collecting a plurality of Web feed subscriptions, wherein each one of said collected Web feed subscriptions is associated with an Internet Protocol (IP) address of a machine through which it was made;
program code for generating at least one suggested Web feed for a user based on similarity of an IP address associated with a machine used by said user to IP addresses associated with said collected Web feed subscriptions; and
program code for displaying said at least one suggested Web feed to said user in a graphical user interface of said machine used by said user.

12. A computer data signal embodied in a carrier wave, said computer data signal having encoded thereon program code for providing targeted Web feed subscription suggestions, said program code comprising:
program code for collecting a plurality of Web feed subscriptions, wherein each one of said collected Web feed subscriptions is associated with an Internet Protocol (IP) address of a machine through which it was made;
program code for generating at least one suggested Web feed for a user based on similarity of an IP address associated with a machine used by said user to IP addresses associated with said collected Web feed subscriptions; and
program code for displaying said at least one suggested Web feed to said user in a graphical user interface of said machine used by said user.

13. A system for providing targeted Web feed subscription suggestions, comprising:
means for collecting a plurality of Web feed subscriptions, wherein each one of said collected Web feed subscriptions is associated with an Internet Protocol (IP) address of a machine through which it was made;
means for generating at least one suggested Web feed for a user based on similarity of an IP address associated with a machine used by said user to IP addresses associated with said collected Web feed subscriptions; and
means for displaying said at least one suggested Web feed to said user in a graphical user interface of said machine used by said user.
